(19) United States
(12) Patent Application Publication
(10) Pub. No.: US 2007/0288618 A1
(43) Pub. Date: Dec. 13, 2007

(54) Method of establishing network topology capable of carrying out relay transmission among subnetworks in backbone network

(75) Inventors: Yeong-bae Yeo, Dalseo-gu (KR); Junkyu Lee, Yuseong-gu (KR); Joonhyuk Kang, Yuseong-gu (KR); June-koo Rhee, Yuseong-gu (KR); Young-kwang Seo, Seoul (KR); Hyuncheol Park, Yuseong-gu (KR); Namseok Chang, Yuseong-gu (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/641,813

(22) Filed: Dec. 20, 2006

(30) Foreign Application Priority Data
Jun. 7, 2006 (KR) 10-2006-0051042

(51) Int. Cl. G06F 15/173

(52) U.S. Cl. 709/223

(57) ABSTRACT

Disclosed is a method of establishing a network topology capable of carrying out a relay transmission among sub-networks in a backbone network having the plural sub-networks composed of at least one device. The method includes each of sub-master devices controlling communications in the respective sub-networks transmitting an ID request message to other sub-master devices; transmitting a response message from the other sub-master devices to the sub-master device having transmitted the ID request message; each of the sub-master devices assigning an ID to the sub-master device having no ID among the sub-master devices having transmitted the response message; and forming a network topology in accordance with whether or not the response message has been transmitted, and in accordance with the order of ID assignments, after the ID is assigned to all the sub-master devices in the backbone network. The network topology enables reliable communications among the respective sub-networks.

### CROSS-REFERENCE TO RELATED APPLICATIONS

This application claims priority from Korean Patent Application No. 10-2006-0051042, filed Jun. 7, 2006, in the Korean Intellectual Property Office, the disclosure of which is incorporated herein by reference in its entirety.

### BACKGROUND OF THE INVENTION

1. Field of the Invention

The present invention relates to a method of establishing a network topology capable of carrying out a relay transmission among sub-networks in a backbone network, and more particularly, to a method of establishing a network topology capable of carrying out a relay transmission among sub-networks in a backbone network and enabling communication to be carried out among the sub-networks included in the back-bone network to secure reliability during communications among the sub-networks.

2. Description of the Prior Art

In recent information communication environments, with the development of communication and network technologies, a wired network environment using a wired medium such as a coaxial cable or an optical cable and a wireless network environment using wireless signals in various frequency bands have been integrated, and the communication, broadcasting and Internet are converged to develop one broadband network.

Accordingly, attention has been paid to a wireless personal area network (WPAN) technology capable of wirelessly connecting home, office and various information appliances within a local area at home and in offices. IEEE 802.15.3 WPAN is a wireless network technology that supports communications between devices at a physical layer and a data link layer for a wireless access in a distance of about 10 m, thereby enabling a variety of application services to be provided.

The wireless network to which the WPAN technology is applied can be divided into two types. In a network type allocating a channel time, a coordinator serves to allocate a channel time in which a wireless network device, which is arbitrarily selected from wireless network devices belonging to a single wireless network, can transmit data to the other wireless network devices. Accordingly, the other wireless network devices can transmit the data in the allocated channel time only. In a network type not allocating a channel time, there is no wireless network device serving as a coordinator and all network devices can transmit the data at any time when the devices want to do so.

The network type having the coordinator function is also referred to as a “coordinator-based wireless network” and forms an independent single wireless network around the coordinator. When a plurality of coordinator-based wireless networks exist in a predetermined space, each of the coordinator-based wireless networks has inherent identification information so as to distinguish from other coordinator-based wireless networks. Although the wireless network devices belonging to the specific coordinator-based wireless network can transmit/receive the data to and from the other network devices during the channel time defined by the coordinator in the coordinator-based wireless network to which the corresponding wireless network devices belong, they cannot communicate with the wireless network devices belonging to another coordinator-based wireless network.

The reason for the inability to communicate with devices belonging to other networks lies in limitations in the range of radio waves, nonexistence of information about other coordinator-based wireless networks, and channel time allocation problems.

Accordingly, it is needed to establish a new network topology for transmitting/receiving the data among the wireless network devices belonging to different coordinator-based wireless networks.

On the other hand, when the network topology is constructed, there may be one or plural routes for transmitting/receiving the data from one coordinator-based wireless network to another coordinator-based wireless network. At this time, if there are plural routes, it may cause a problem that a route should be selected on the basis of a certain criterion. In addition, when selecting a route, a connection quality should be considered. Accordingly, when establishing the network topology, a method of selecting a communication route among the respective coordinator-based wireless networks should also be provided in consideration of the connection quality.

### SUMMARY OF THE INVENTION

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above. The present invention provides a method of establishing a network topology capable of carrying out a relay transmission among sub-networks in a backbone network, enabling communication to be carried out among devices belonging to different coordinator-based wireless networks and improving the reliability and the connection quality.

The foregoing and other objects and advantages are substantially realized by providing a method of establishing a network topology capable of carrying out a relay transmission among sub-networks in a backbone network having the plural sub-networks composed of at least one device, according to the present invention, which includes each of sub-master devices that control communications in the respective sub-networks transmitting an ID request message to other sub-master devices except its own self; transmitting a response message from each of other sub-master devices to the sub-master device having transmitted the ID request message; each of the sub-master devices assigning an ID to the sub-master device having no ID among the sub-master devices having transmitted the response message; and forming a network topology, which is a route connectable among the respective sub-master devices, in accordance with whether or not the response message has been transmitted, and in accordance with the order of ID assignments, when the ID is assigned to all the sub-master devices in the backbone network.

The backbone network may include a super master device selected among the sub-master devices and controlling communications among the sub-networks, and the step of transmitting the ID request message may include transmitting the ID request message from the super master device to each of the sub-master devices.

The step of transmitting the response message may include transmitting the response message from each of the sub-master devices to the super master device.

The step of assigning the ID may include assigning an ID to a sub-master device having a connection quality higher than a predetermined level, among the sub-master devices having transmitted the response message, and setting the sub-master device having the ID assigned thereto as an n-th node master device.

The step of transmitting the ID request message may include transmitting the ID request message from the n-th node master device to the sub-master devices except its own self.

The step of transmitting the ID request message may include transmitting the ID request message from the n-th node master device to the super master device.

The step of transmitting the response message may include transmitting the response message from the sub-master device having received the ID request message to the n-th node master device.

The step of transmitting the response message may include transmitting the response message from the super master device to the n-th node master device.

The step of assigning the ID may include assigning an ID to a sub-master device having a connection quality higher than a predetermined level and having no ID, among the sub-master devices having transmitted the response message to the n-th node master device, and setting the sub-master device having the ID assigned thereto as a (n+1)-th node master device.

The steps of transmitting the ID request message, transmitting the response message, and assigning the ID may be repeated until the ID is assigned to all the sub-master devices belonging to the backbone network.

The step of forming the network topology may include transferring information about each of the sub-master devices to the super master device, when the ID is assigned to all the sub-master devices belonging to the backbone network.

The step of transferring the information may include transferring information including a connection quality of a link for connecting each of the sub-master devices from the lower order sub-master device to the upper order sub-master device.

The method may further include the super master device recognizing a network topology, which is a route connectable among the respective super master devices, based on the information provided from each of the sub-master devices having the ID assigned thereto.

The method may further include the super master device allocating channel time allocation (CTA) of each of the sub-master devices having the ID assigned thereto to a super frame.

The ID request message may be included in a contention access period (CAP) of the super frame.

The method may further include requesting information transfer from a departure device belonging to one sub-network to a destination device belonging to another sub-network; the super master device comparing connection qualities of plural routes connecting the departure device and the destination device in accordance with the network topology; and transferring the information through a route decided to have an excellent connection quality, among the plural routes.

In another aspect of the present invention, there is provided a method of establishing a network topology capable of carrying out a relay transmission among sub-networks in a backbone network, having sub-master devices controlling communications in the sub-networks composed of at least a part of plural devices included in the backbone network and a super master device controlling communications among the sub-networks, which includes transmitting an ID request message for an ID assignment from the super master device to each of the sub-master devices; transmitting a response message to the ID request message from each of the sub-master devices to the super master device; assigning an ID to a sub-master device having a connection quality higher than a predetermined level, among the sub-master devices having transmitted the response message; transmitting an ID request message for an ID assignment from the sub-master device having the ID assigned thereto to each of the sub-master devices; transmitting a response message to the ID request message from each of the sub-master devices to the sub-master device having the ID assigned thereto; assigning an ID to a sub-master device having a connection quality higher than a predetermined level and having no ID, among the sub-master devices having transmitted the response message; and forming a network topology, which is a route connectable among the respective sub-master devices, in accordance with whether or not the response message has been transmitted, and in accordance with the order of ID assignments.

### BRIEF DESCRIPTION OF THE DRAWINGS

The above and/or other aspects of the present invention will be more apparent by describing certain embodiments of the present invention with reference to the accompanying drawings, in which:

FIG. 1 is a view illustrating a structure of a backbone network having coordinator-based sub-networks according to an embodiment of the invention;

FIGS. 2A to 2E illustrate a process of establishing a network topology among a super master device and each of sub-master devices in FIG. 1;

FIG. 3 is a view illustrating a structure of a general super frame;

FIG. 4 is a graph of a BER curve for calculating a SNR (Signal-to-Noise Ratio) which is a measurement criterion of a connection quality;

FIG. 5 is a table showing a process of transferring information of a network topology according to an embodiment of the invention to a super master device;

FIG. 6 is a flowchart illustrating a process of establishing a network topology according to an embodiment of the invention; and

FIG. 7 is a flowchart illustrating a relay transmission process in a backbone network in which a network topology is established according to an embodiment of the invention.

### DETAILED DESCRIPTION OF EXEMPLARY EMBODIMENTS

Exemplary embodiments of the present invention will be described in greater detail with reference to the accompanying drawings.

In the description of the exemplary embodiments, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

According to the invention, a network topology enabling a relay transmission among sub-networks is established in a backbone network. In following embodiments, a method and process of embodying the network topology will be described. Then, a process of efficiently relay transmitting information among devices belonging to the respective sub-networks in accordance with the established network topology will be described.

In the embodiments of the present invention to be explained later, only a process of embodying a network topology among sub-master devices in the sub-networks will be described. However, it should be noted that the method of establishing the network topology can be applied to establish a network topology among plural devices in a sub-network having the plural devices.

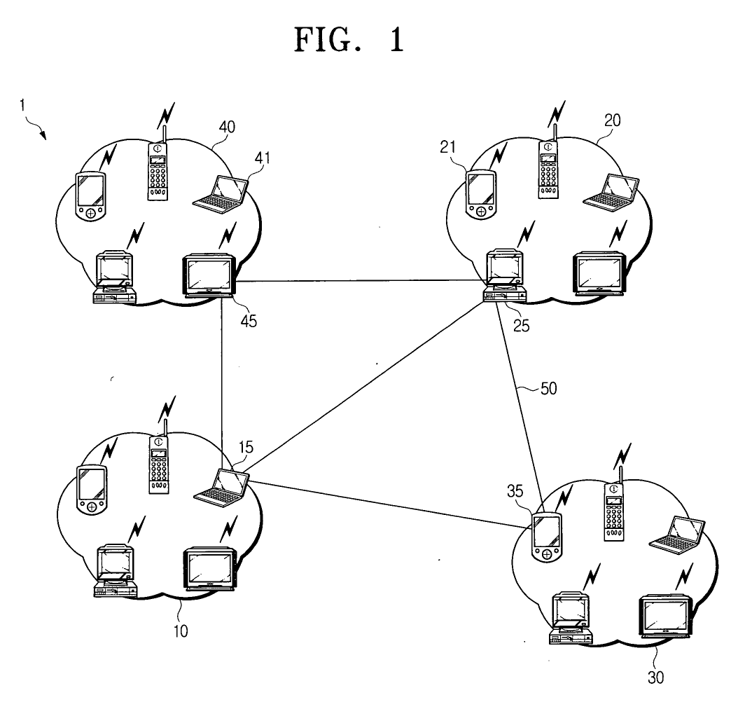

FIG. 1 is a view illustrating a structure of a backbone network having coordinator-based sub-networks according to an embodiment of the invention.

The backbone network 1 comprises plural coordinator-based sub-networks in each of which sub-master devices 15, 25, 35, 45 are set as a coordinator. One of the plural sub-master devices 15, 25, 35, 45 included in the backbone network 1 is set as a super master device 45 for controlling communications of the backbone network 1. The super master device 45 controls a network topology formation among the plural sub-master devices 15, 25, 35 and communications among the sub-networks.

Herein, the super master device 45 is one of the sub-master devices 15, 25, 35, 45 and the sub-master devices 15, 25, 35, 45, including the super master device 45, may be formed as one of an appliance, a router, a wired/wireless bridge and a PNC (Piconet Coordinator). Each of the sub-master devices 15, 25, 35, 45 can carry out the communication in a wired or wireless manner. When carrying out the communication in a wired manner, a coaxial cable, an optical cable, a power line, a telephone line and the like can be used. In addition, each of devices belonging to the sub-networks can be connected to the sub-master devices 15, 25, 35, 45 of the corresponding sub-networks in a wired or wireless manner.

FIG. 1 is a view illustrating the backbone network 1 comprising the first to fourth sub-networks 10, 20, 30, 40. In this particular example, the sub-master devices of the first to third sub-networks 10, 20, 30 are referred to as first to third sub-master devices 15, 25, 35, respectively, and the sub-master device of the fourth sub-network 40 is set as the super master device 45.

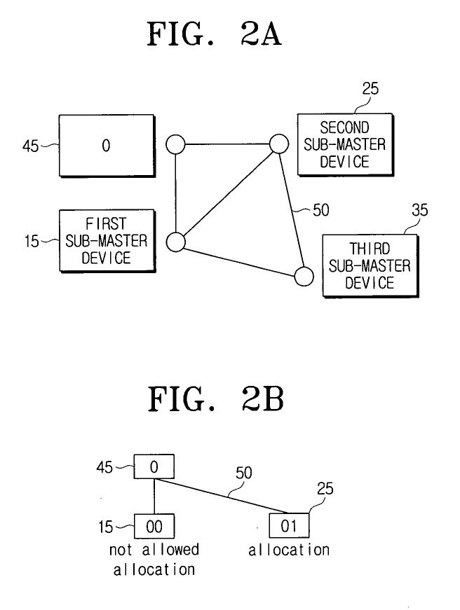

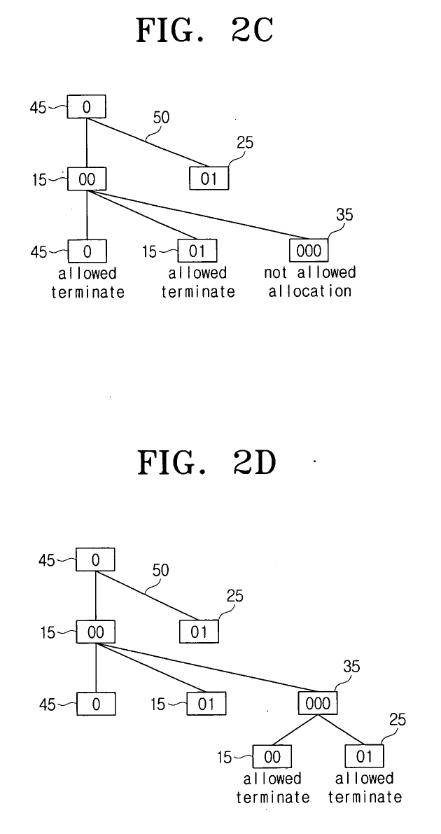

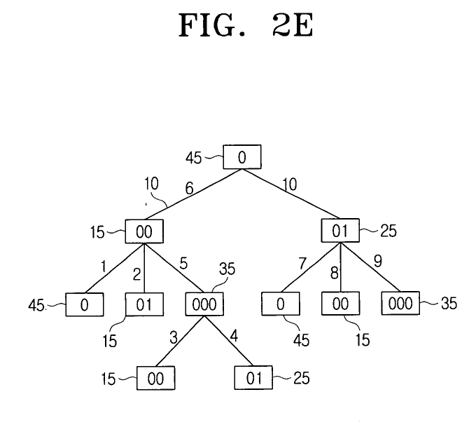

FIGS. 2A to 2E illustrate a process of establishing a network topology among a super master device and each of sub-master devices in FIG. 1.

FIG. 2A shows topographical positions among the super master device 45 and each of the sub-master devices 15, 25, 35. An ID “0” is assigned to the super master device 45 and no ID is assigned to the first to third sub-master devices 15, 25, 35. FIG. 2A also shows channels 50 connecting the super master device 45 and the first to third sub-master devices 15, 25, 35 to communicate with each other. Herein, each of the channels 50 directly interconnects the super master device 45 and the first to third sub-master devices 15, 25, 35 adjacent to each other, and there is no channel 50 directly connecting the super master device 45 and the third sub-master device 35 which are relatively far away from each other. At this time, the channel 50 between the super master device 45 and the third sub-master device 35 has been removed because a connection quality thereof is lower than a predetermined level. The measurement of the connection quality and the decision of a communication route relating to it will now be described.

FIG. 2B is a view illustrating a state that a network topology is established for the super master device 45.

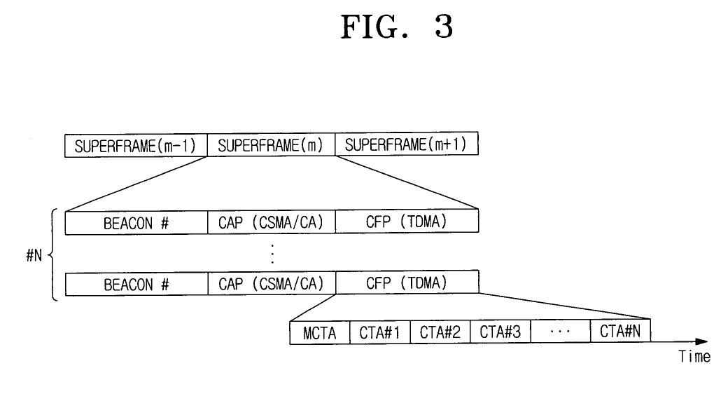

The super master device 45 transmits a beacon message, which is an ID request message for requesting an ID, to the first to third sub-master devices 15, 25, 35 included in the backbone network 1. At this time, the super master device 45 transmits the beacon message in a super frame unit as illustrated in FIG. 3.

The super frame consists of a beacon area, a CAP (Contention Access Period) area and a CFP (Contention Free Period) area. The beacon area provides various information elements necessary for timing synchronization and operation of the sub-network. The data is carried in the CAP area depending on competition with the other sub-master devices, using a CSMA/CA (Carrier Sense Multiple Access/Collision Detect) technique having a back-off function. The CFP area comprises a MCTA (Management of Channel Time Allocation) and a plurality of CTAs (Channel Time Allocation). The CTA is allocated to the sub-master device having requested a channel time. In the MCTA, a relationship between each of the sub-master devices 15, 25, 35 and each CTA has been defined.

The first to third sub-master devices 15, 25, 35 having received the beacon message of the super frame, form transfer response messages to the super master device 45. Then, the super master device 45 assigns a master device ID (MASTER_DEV_ID) to the first to third master devices 15, 25, 35 in accordance with the response messages provided from the first to third master devices 15, 25, 35. The MASTER_DEV_ID is a MAC address, and is hierarchically assigned, depending on positions of the super master device 45 and each of the sub-master devices 15, 25, 35 on the network topology.

On the other hand, the super master device 45 measures connection qualities between the super master device 45 and each of the sub-master devices 15, 25, 35 using the response messages provided from the first to third master devices 15, 25, 35. At this time, a method of measuring a connection quality using the existing response signal based on IEEE 802.11 is used.

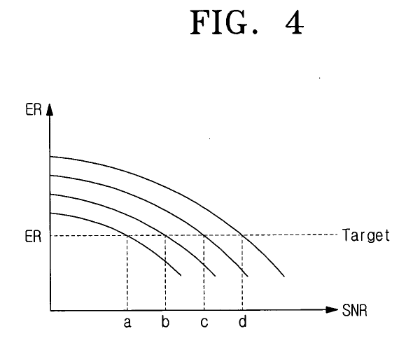

FIG. 4 is a graph of a BER curve for calculating a SNR (Signal-to-Noise Ratio) that is a measurement criterion of a connection quality.

As shown, there is a target ER (Error Rate) level when the backbone network 1 is designed. The data rate is determined on the basis of SNR of each point at which the target ER and each BER curve meet. When each point of SNR is indicated as a, b, c and d, the data rate is set as follows.

SNR<a→data transmission is impossible

a<SNR<b→53.3 Mbps

b<SNR<c→110 Mbps

c<SNR<d 160 Mbps

SNR>d+320 Mbps

Accordingly, the connection quality is determined in accordance with the SNR. When the SNR is determined, it is determined that the data can be transmitted at certain speed.

On the other hand, the super master device 45 does not assign the MASTER_DEV_ID if the sub-master device has the MASTER_DEV_ID already. Even when the super master device 45 has assigned the MASTER_DEV_ID, if the connection quality is lower than a predetermined level, i.e., SNR<a, as a measurement result of the connection quality with each of the sub-master devices 15, 25, 35, the assigned MASTER_DEV_ID is removed from the corresponding sub-master device.

Accordingly, as shown in FIG. 2B, the super master device 45 assigns “00” and “01” to the first and second sub-master devices 15, 25 only as the MASTER_DEV_ID, and removes the MASTER_DEV_ID assigned to the third sub-master device 35 which has a connection quality lower than the predetermined level because it is far from the super master device 45. In this case, the first and second sub-master devices 15, 25 having the MASTER_DEV_ID assigned from the super master device 45 are arranged as a first-order node of the network topology and become a first-order node master device at the same time.

In this manner, when the first-order node master device is determined, the super master device 45 defines in what order the CTA will be allocated to the MCTA area of the CFA area of the super frame, with regard to the first and second sub-master devices 15, 25. Then, it allocates CTA to the CTA area, with regard to each of the first and second sub-master devices 15, 25, as defined in the MCTA.

In this manner, when the decision on the first-order node master devices 15, 25 and the allocation of CTA are completed, the first-order node master devices 15, 25 assign an ID to the other sub-master devices in the same manner as carried out at the super master device 45.

In other words, the first sub-master device 15 and the second sub-master device 25 determined as the first-order node master devices 15, 25 transmit an ID request message to the other master devices except its own self, respectively. In addition, since the super master device 45 is also the sub-master device, the first-order node master devices 15, 25 transmit the ID request message to the super master device 45, too.

First, the first sub-master device 15 transmits a beacon message, which is the ID request message, to the super master device 45 and the second and third master devices 25, 35. Then, the super master device 45 and the second and third master devices 25, 35 having received the beacon message transmit response messages to the first sub-master device 15.

When the first sub-master device 15 receives the response messages from the super master device 45 and the second and third master devices 25, 35, it determines whether the MASTER_DEV_ID is provided and the connection quality is higher than a predetermined level. First, the first sub-master device 15 assigns “000”, as a MASTER_DEV_ID, to the third sub-master device 35 having no MASTER_DEV_ID and sets the third sub-master device 35 as a second-order node master device. Then, the first sub-master device 15 sets the sub-master device having the connection quality higher than the predetermined level as a second-order node which is a lower node of the first sub-master device 15, and the super master device 45 and the second and third sub-master devices 25, 35 are set as the second-order node. Accordingly, a network topology as shown in FIG. 2C is formed, and the third sub-master device 35 becomes a second-order node master device.

Then, the first sub-master device 15 allocates the CFA of the super master device 45 and the second and third master devices 25, 35, which are the second-order nodes, to the CFP area of the super frame thereof.

In this manner, when the construction of the network topology by the first sub-master device 15 is completed, it is checked whether a lower node master device is created to the first sub-master device 15. At this time, since the third sub-master device 35, which is the second-order node master device, is present, a process proceeds which establishes a network topology for the third sub-master device 35.

First, the third sub-master device 35 transmits a beacon message to the super master device 45 and the first and second sub-master devices 15, 25. Then, the super master device 45 and the first and second sub-master devices 15, 25 transmit response messages to the third sub-master device 35. The third sub-master device 35 determines the connection quality and whether or not the assignment of the MASTER_DEV_ID using the response messages. At this time, since the MASTER_DEV_ID has been already assigned to the first and second sub-master devices 15, 25, it is not necessary to assign the MASTER_DEV_ID at the third sub-master device 35. In addition, since the connection quality with the super master device 45 is lower than the predetermined level, a network topology as a lower node is established for the first and second sub-master devices 25 only. Accordingly, a network topology as shown in FIG. 2D is established.

Then, the third sub-master device 35 allocates the CTA to the CFP area of the super frame thereof, with regard to the first and second sub-master devices 15, 25

In this manner, when the network topology for the first and third sub-master devices 15, 35 is completed, a process of establishing a network topology for the second sub-master device 25 which is the first-order node master device is carried out.

The second sub-master device 25 transmits a beacon message to the super master device 45 and the first and third sub-master devices 15, 35 and receives a response messages from the super master device 45 and the first and third sub-master devices 15, 35. Likewise the first sub-master device 15, the second sub-master device determines whether the MASTER_DEV_ID is provided and the connection quality is higher than the predetermined level. At this time, since the super master device 45 and the first and third sub-master devices 15, 35 have the MASTER_DEV_ID already, the second sub-master device 25 does not assign a separate MASTER_DEV_ID. Then, the second sub-master device 25 sets the super master device 45 and the first and third sub-master devices 15, 35 determined to have the connection quality higher than the predetermined level, as a lower node of the second sub-master device 25.

Then, the second sub-master device 25 allocates the CTA to the super frame, with respect to the super master device 45 and the first and third sub-master devices 15, 35.

Accordingly, as shown in FIG. 2E, the process of establishing the network topology is completed, because the super master device 45 and the first and second sub-master devices 15, 25 are present at the lower node of the second sub-master device 25 but there is no lower node master device having a separate MASTER_DEV_ID.

In this manner, when the network topology for the super master device 45 and each of the sub-master devices 15, 25, 35 is established, a process proceeds which collects information about each of the routes constituting the network topology at the super master device 45. The information about each route includes the super frame structures of the super master device 45 and the first to third sub-master devices 15, 25, 35.

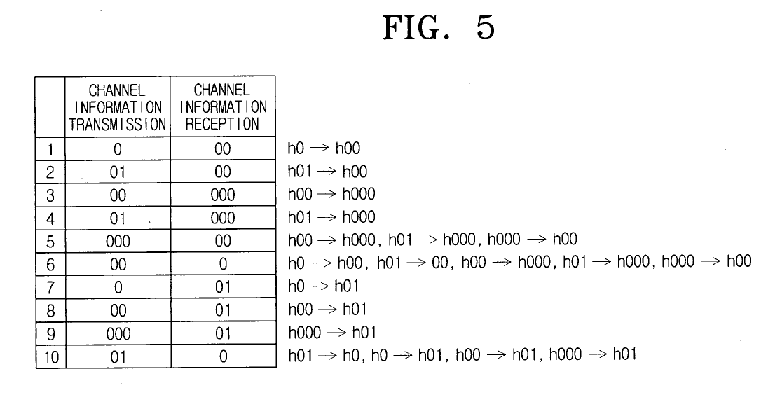

FIG. 5 is a table showing a process of transferring information of a network topology according to an embodiment of the invention to a super master device. In FIG. 5, the numerals are the orders of transferring the network topology information and same as the numerals indicated at each of the channels 50. As shown, the information is provided along each of the routes in orders arranged in the network topology.

First, the channel information is collected from the leftmost route. The information collection is carried out from the lowest node to the upper mode. Accordingly, the information is provided from the super master device 45, which is the lowest node (No. 1 in the table) of the leftmost route, to the first sub-master device 15 that is the first-order node master device. The super master device 45 broadcasts the MASTER_DEV_ID thereof and the connection quality of the channel.

Then, the first sub-master device 15, which is the upper node, receives the information from the super master device 45, and, as shown in No. 2 of the table, the second sub-master device 25 broadcasts the MASTER_DEV_ID thereof and the connection quality of the channel. Accordingly, the first sub-master device 15 receives the information from the second sub-master device 25.

Then, as shown in No. 3 of the table, the first sub-master device 15 broadcasts the MASTER_DEV_ID thereof and the connection quality of the channel, and the third sub-master device 35 receives the information from the first sub-master device 15. Likewise, as shown in No. 4 of the table, the second sub-master device 25 broadcasts the MASTER_DEV_ID thereof and the connection quality of the channel, and the third sub-master device 35 receives the broadcasted information. Then, as shown in No. 5 of the table, the third sub-master device 35 broadcasts the information, which is received from the first and second sub-master devices 15, 25 through the processes of Nos. 3 and 4 in the table. At this time, the third sub-master device broadcasts the MASTER_DEV_ID thereof, the MASTER_DEV_ID of the first and second sub-master devices 15, 25, which are the lower nodes thereof, and the connection quality of the channel.

In this manner, when the information is collected from each of the sub-master devices 15, 25, 35 connected to the first sub-master device 15, among the first-order node master devices, the first sub-master device 15, as shown in No. 6 of the table, broadcasts the collected information, the MASTER_DEV_ID thereof, the MASTER_DEV_ID of the first and second sub-master devices 15, 25, which are the lower nodes thereof, and the connection quality of the channel. Then, the super master device 45 receives the information from the first sub-master device 15.

On the other hand, the information collection from the second sub-master device 25 that is another first-order node master device is also carried out through the same process.

First, as shown in No. 7 of the table, the super master device 45 broadcasts the super MASTER_DEV_ID thereof and the connection quality of the channel. Then, the second sub-master device 25 receives the information from the super master device 45.

Likewise, as shown in Nos. 8 and 9 of the table, the first and third sub-master devices 15, 35 broadcast the MASTER_DEV_ID thereof and the connection quality of the channel. Then, the second sub-master device 25 receives the information from the first and third sub-master devices 15, 35.

Then, the second sub-master device 25 broadcasts the collected information, the MASTER_DEV_ID thereof, the MASTER_DEV_ID of the super master device 45 and the second and third sub-master devices that are the lower nodes thereof, and the connection quality of the channel. Then, the super master device 45 receives the information from the second sub-master device 25.

In this manner, when the information is received from each of the sub-master devices 15, 25, 35 constituting each route of the network topology, the super master device 35 has the information including the structure of the network topology as shown in FIG. 2E and the connection quality of each route. The super master device 45 processes each information to define the CTA, which is allocated to each of the sub-master devices 15, 25, 35 depending on the respective routes, in the MCTA section of the CFP area of the super frame, and to allocate the CTA to each of the sub-master devices 15, 25, 35.

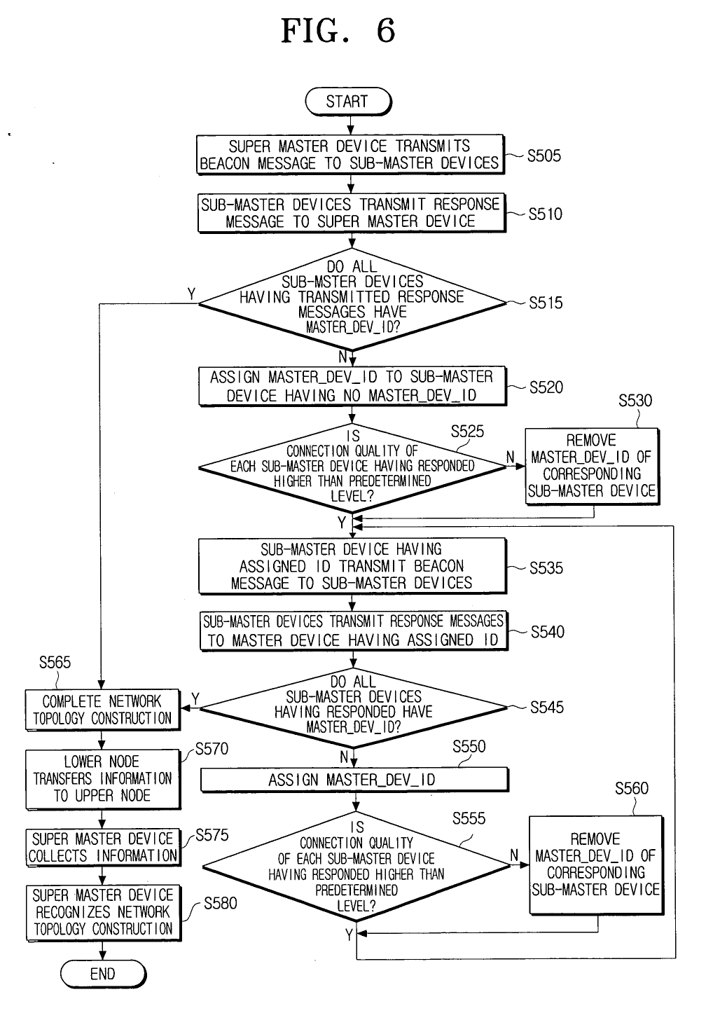

FIG. 6 is a flowchart illustrating a process of establishing a network topology according to an embodiment of the invention.

In order to establish a network topology, initialization for construction of each sub-network, setting of the sub-master devices of each sub-network, initialization of the backbone network 1, and setting of the super master device 45 are first performed.

When such operations are completed, the super master device 45 transmits a beacon message to each of the sub-master devices 15, 25, 35 (S505). Then, each of the sub-master devices 15, 25, 35 transmits a response message to the super master device 45 (S510). When each of the sub-master devices 15, 25, 35 having transmitted the response messages has the MASTER_DEV_ID (S515-Y), the super master device 45 determines that the network topology has been completed (S565).

However, when the sub-master device having no MASTER_DEV_ID exists among the respective sub-master devices 15, 25, 35 having transmitted the response messages (S515-N), the super master device 45 assigns the MASTER_DEV_ID to those of the sub-master devices 15, 25, 35 (S520) having no MASTER_DEV_ID. Then, the super master device determines the connection quality, based on the response messages provided from each of the sub-master devices 15, 25, 35. When the connection quality to any of the sub-master devices is lower than the predetermined level, i.e., SNR<a (S525-N), the super master device 45 removes the MASTER_DEV_ID of the corresponding sub-master device (S530).

Then, the first-order node master device, to which the MASTER_DEV_ID has been assigned from the super master device 45, transmits the beacon message to the sub-master devices except its own self, i.e., to the super master device 45 and the other sub-master devices in the backbone network 1 (S535). When the response messages are received from the super master device 45 and the other sub-master devices in the backbone network 1 (S540), the first-order node master device determines whether the MASTER_DEV_ID is provided (S545) and assigns the MASTER_DEV_ID to the other sub-master devices having no MASTER_DEV_ID (S550). Then, the first-order node master device determines whether the connection quality is satisfied (i.e., SNR is less than a (SNR<a)) (S555), and removes the MASTER_DEV_ID of the sub-master device not satisfying the connection quality (S560).

In this manner, a second-order node master device, to which the MASTER_DEV_ID has been assigned from the first-order node master device, assigns the MASTER_DEV_ID to a third-order node master device through the same process as the first-order node device. These processes are continued until the MASTER_DEV_ID is assigned to all the sub-master devices in the backbone network 1.

When the MASTER_DEV_ID is assigned to all the sub-master devices in the backbone network 1, it is determined that the network topology establishment has been completed (S565). Then, the information including the connection quality of each channel from the super master device 45 and each of the sub-master devices 15, 25, 35 included in the respective routes constituting the network topology is transferred to the upper node from the lower node (S570), and finally transferred to the super master device 45 (S575).

The super master device 45 stores the construct of the network topology and the connection quality information about each channel (S580), and allocates the CTA to the super frame, with regard to the sub-master devices 15, 25, 35

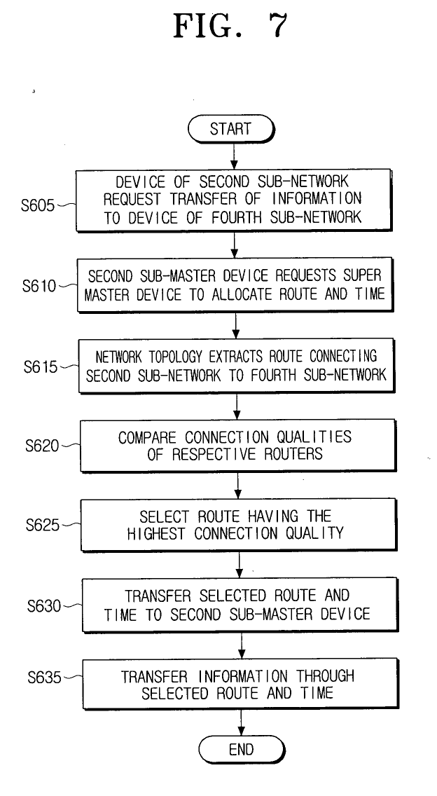

FIG. 7 is a flowchart illustrating a relay transmission process in a backbone network in which a network topology is established according to an embodiment of the invention.

FIG. 7 exemplary shows a process of transmitting the information from a PDA 21, which is a device belonging to the second sub-network 20, to a notebook 41, which is a device belonging to the fourth sub-network 40.

First, the information transfer from the PDA 21 of the second sub-network 20 to the second sub-master device 25 that is the master device of the second sub-network 20 is requested, and then to the notebook 41 of the fourth sub-network 40 (S605). Then, the second sub-master device 25 requests the super master device 45 to allocate a route and time for the information transfer to the notebook 41 of the fourth sub-network 40 (S610).

The super master device 45 having received the request extracts a possible route from the pre-stored network topology (S615). At this time, according to the network topology shown in FIG. 2E, the route reaching the fourth sub-network 40 from the second sub-network 20, i.e., the route reaching the super master device 45 from the second sub-master device 25 comprises three types, i.e., a route connecting to Nos. 2 and 6, a route connecting to Nos. 4, 5 and 6 and a route of No. 10. On the other hand, it is assumed that the PDA 21, the second sub-master device 25, the notebook 41 and the super master device 45 directly communicate, respectively.

When the route is extracted, the super master device 45 compares the connection qualities of the respective routes (S620). Since the super master device 45 has the information about the connection qualities of respective channels, it should calculate the connection quality of the whole route when the plurality of channels are connected. At this time, the super master device 45 compares the connection qualities among the routes, using Equation (1).

$$\frac{B C}{B + C} > A \qquad ( 1 )$$

Here, A, B and C are channels of the respective routes, B and C are channels constituting one route, and A is a single route. When satisfying the equation 1, the super master device 45 transfers the information to the route passing through B and C, rather than A route. If three channels constitute the route, it may be possible to compare the connection qualities among the routes, using Equation (2).

$$\frac{B C D}{B C + C D + D B} > A \qquad ( 2 )$$

Here, B, C and D are channels constituting one route, and A is a single route.

The super master device 45 compares the connection qualities among the respective routes with the equations 1 and 2 and selects a route having the highest connection quality when communicating among the sub-networks (S625). Then, the super master device 45 transfers the information about the corresponding route and time allocated, to the second sub-master device 25 (S630). The second sub-master device 25 allocates the route and time to the PDA 21 and controls the information to be transferred through the corresponding route and time (S635).

In this manner, according to the method of establishing a network topology of the backbone network 1, it is possible to set a network topology enabling the communication to be carried out among the respective sub-networks included in the backbone network 1. In addition, when carrying out the communication among the respective sub-networks, the information is transferred through the route having the highest connection quality, so that the reliability of the communication can be secured.

As described above, according to the invention, it is possible to set a network topology enabling the communication to be carried out among the respective sub-networks included in the backbone network. In addition, when carrying out the communication among the respective sub-networks, the information is transferred through the route having the highest connection quality, so that the reliability of the communication can be secured.

The foregoing exemplary embodiments are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method of establishing a network topology capable of carrying out a relay transmission among sub-networks in a backbone network having the plural sub-networks composed of at least one device, the method comprising:
causing each of sub-master devices for controlling communications in the respective sub-networks to transmit an ID request message to other sub-master devices of other sub-networks;
transmitting a response message from each sub-master device receiving the ID request message, to the sub-master device having transmitted the ID request message;
upon receiving a response message, causing each of the sub-master devices receiving a response message to assign an ID to the sub-master device having no ID among the sub-master devices having transmitted the response message; and
forming a network topology, which is a route connectable among the respective sub-master devices, in accordance with whether or not the response message has been transmitted, and in accordance with the order of ID assignments, when the ID is assigned to all of the sub-master devices in the backbone network.

2. The method of claim 1, wherein the backbone network comprises a super master device selected among the sub-master devices, said super master device controlling communications among the sub-networks, and wherein the step of transmitting the ID request message comprises transmitting the ID request message from the super master device to each of the sub-master devices.

3. The method of claim 2, wherein the step of transmitting the response message comprises transmitting the response message from each of the sub-master devices to the super master device.

4. The method of claim 3, wherein the step of assigning the ID comprises assigning an ID to a sub-master device having a connection quality higher than a predetermined level, among the sub-master devices having transmitted the response message; and setting the sub-master device having the ID assigned thereto as an n-th node master device.

5. The method of claim 4, wherein the step of transmitting the ID request message comprises transmitting the ID request message from the n-th node master device to the sub-master devices of other sub-networks.

6. The method of claim 4, wherein the step of transmitting the ID request message comprises transmitting the ID request message from the n-th node master device to the super master device.

7. The method of claim 5, wherein the step of transmitting the response message comprises transmitting the response message from the sub-master device having received the ID request message to the n-th node master device.

8. The method of claim 6, wherein the step of transmitting the response message comprises transmitting the response message from the super master device to the n-th node master device.

9. The method of claim 7, wherein the step of assigning the ID comprises:
assigning an ID to a sub-master device having a connection quality higher than a predetermined level and having no ID, among the sub-master devices having transmitted the response message to the n-th node master device, and
setting the sub-master device having the ID assigned thereto as an (n+1)-th node master device.

10. The method of claim 1, wherein transmitting the ID request message, transmitting the response message and assigning the ID are repeated until an ID is assigned to all of the sub-master devices belonging to the backbone network.

11. The method of claim 1, wherein the step of forming the network topology comprises transferring information about each of the sub-master devices to the super master device, when the ID is assigned to all the sub-master devices belonging to the backbone network.

12. The method of claim 11, wherein the step of transferring the information comprises transferring information including a connection quality of a channel for connecting each of the sub-master devices to communicate from the lower order sub-master device to the upper order sub-master device.

13. The method of claim 1, further comprising the super master device recognizing a network topology which is a route connectable among the respective super master devices, based on the information provided from each of the sub-master devices having the ID assigned thereto.

14. The method of claim 1, further comprising the super master device allocating channel time allocation (CTA) of each of the sub-master devices having the ID assigned thereto to a super frame.

15. The method of claim 1, wherein the ID request message is transmitted in a contention access period (CAP) of the super frame.

16. The method of claim 1, further comprising:
requesting information transfer from an originating device belonging to one sub-network to a destination device belonging to another sub-network;
the super master device comparing connection qualities of plurality of routes connecting the originating device and the destination device in accordance with the network topology; and
transferring the information through a route decided to have superior connection quality among the plural routes.

17. A method of establishing a network topology capable of carrying out a relay transmission among sub-networks in a backbone network having sub-master devices for controlling communications in each respective sub-network, and a super master device for controlling communications among the sub-networks, the method comprising:
transmitting an ID request message for an ID assignment from the super master device to each of the sub-master devices;
transmitting a response message to the ID request message from each of the sub-master devices to the super master device;
assigning an ID to a sub-master device having a connection quality higher than a predetermined level, among the sub-master devices having transmitted the response message;
transmitting a secondary ID request message for an ID assignment from the sub-master device having the ID assigned thereto to each of the other sub-master devices;
transmitting a response message to the secondary ID request message from each of the sub-master devices to the sub-master device having the ID assigned thereto;
assigning an ID to a sub-master device having a connection quality higher than a predetermined level and having no ID, among the sub-master devices having transmitted the response message to the secondary ID request message; and
forming a network topology, which is a route connectable among the respective sub-master devices, in accordance with whether or not the response message has been transmitted and in accordance with the order of ID assignments.

18. The method of claim 17, further comprising:
prior to forming the network topology:
transmitting an n^{th} ID request message for an ID assignment from the sub-master device having the ID assigned thereto to each of the other sub-master devices;
transmitting a response message to the n^{th} ID request message from each of the sub-master devices to the sub-master device having the ID assigned thereto;
assigning an ID to a sub-master device having a connection quality higher than a predetermined level and having no ID, among the sub-master devices having transmitted the response message to the n^{th} ID request message; and
forming a network topology, which is a route connectable among the respective sub-master devices, in accordance with whether or not the response message has been transmitted and in accordance with the order of ID assignments.
